(19) United States
(12) Patent Application Publication
(10) Pub. No.: US 2012/0074887 A1
(43) Pub. Date: Mar. 29, 2012

(54) Back EMF Measuring Method for Multi-Phase BLDC Motor

(76) Inventors: Guo-Jhih Yan, Kaohsiung City (TW); Kai-Hsiung Chang, Yunlin County (TW); Sheng-Chan Yen, Kaohsiung City (TW); Yen-Chih Liu, Kaohsiung City (TW); Jia-Chang Chen, Kaohsiung City (TW)

(21) Appl. No.: 13/213,304

(22) Filed: Aug. 19, 2011

(30) Foreign Application Priority Data
Sep. 28, 2010 (TW) 099132794

(51) Int. Cl. H02P 6/18

(52) U.S. Cl. 318/400.34

(57) ABSTRACT

A back EMF measuring method for multi-phase BLDC motor is proposed, which includes a driving process and a measuring process. The driving process energizes a plurality of phase windings of a detected motor by driving signals generated by a computing unit to rotate a rotor of the detected motor to a predetermined speed. The measuring process selects one of the phase windings as a target phase winding, continuously sends the driving signals to the phase windings other than the target phase winding but stops the driving signal sent to the target phase winding by the computing unit, and measures the back EMF of the target phase winding by a signal sensing unit.

### BACKGROUND OF THE INVENTION

1. Field of the Invention

The present invention relates to a back EMF measuring method and, more particularly, to a back-EMF measuring method for multi-phase brushless DC motor.

2. Description of the Related Art

Generally, in the development of a brushless DC motor, there is a plurality of performance parameters to be considered. In these performance parameters, the back EMF constant is especially detected for a motor no matter it is a well designed prototype or a product of mass production to verify whether this motor is qualified or not since the back EMF constant affects the performance of a motor greatly.

Conventionally, the way to detect the back EMF constant of a motor includes connecting an output shaft of a servo motor to that of a detected motor through a shaft coupling and then rotating the rotor of the detected motor by the servo motor. Thereby, coils of a stator of the detected motor generate back EMF when the rotor is rotated, and the back EMF constant can be obtained once the value of the back EMF is detected and rotating speed of the servo motor is provided. However, this conventional way cannot be applied to a detected motor without an output shaft, and accuracy of shaft-alignment between the output shafts of the servo motor and detected motor is strictly required to avoid any measuring error. Another kind of back EMF measuring method such as the invention disclosed by “Torque Measuring System and Method for Low Power Motor” with Taiwan Patent publication number 200842333 and Patent number I331212 is proposed to solve the shaft-alignment problem, which arranges a fan wheel on the output shaft of the detected motor and turns the fan wheel by a strong airflow to detect the back EMF thereof and thus to obtain its back EMF constant. However, this measuring method cannot be applied to a detected motor without an output shaft either. Besides, since the detected motors of these two conventional measuring methods are all driven by external force, each of the two conventional measuring methods leads to an additional device mounted on the output shaft thereof and measuring error caused by this mechanical arrangement.

In order to avoid the additional arrangement on the output shaft of a detected motor, another kind of conventional measuring method such as the invention disclosed by “Differentiating Method for Magnetized Rotor by Back EMF Measuring” with Taiwan Patent publication number 488125 and Patent number 156969 is presented. A standard stator having a detecting coil, which is made according to a detected rotor, have to be previously prepared for performing the disclosed measuring method in this patent. The detecting coil can measure the back EMF of the detected rotor when it is rotated by the standard stator. Although it is no more necessary to apply external force or shaft coupling to the detected rotor for driving it, preparation for the standard stator may lead to additional cost since different kinds of standard stators for detected rotors in various sizes and with different number of poles are needed. Besides, the back EMF obtained by the standard stator has to be further calculated to match the motor having the detected rotor.

Therefore, other kinds of conventional measuring method such as the invention disclosed by “Method and Circuit for Testing Motor” with Taiwan Patent number 1298572 are proposed to avoid the use of a detecting coil. This conventional measuring method drives a rotor of a detected motor to a predetermined rotational speed by a driver connecting with coils of a stator of the detected motor, turns off the driver once the predetermined rotational speed is achieved, and then measures the back EMF of the detected motor while its rotor still rotates for inertia in a speed range. However, although the rotor may keep rotating after the driver is turned off, a time period for back EMF measurement of this measuring method is limited and cannot be longer than the time period wherein the speed of the rotor is in the speed range due to inertia.

As a result, further inventions need not to turn off their drivers such as an invention disclosed by “Measuring Method for back EMF constant of Motor” with Taiwan Patent number 1227331 are proposed. The measuring method of this invention includes: connecting two phase windings of a detected three-phase motor in series with the other phase winding of the three-phase motor floating; and driving the detected motor with the two serially connected phase windings by a single phase driving mode as well as detecting the three phase voltages of the detected motor, so as to obtain the back EMF constant. Specifically, in the single phase driving mode, a Hall signal of the detected three-phase motor is delivered to a signal pin of a driver, and signals transferred from the Hall signal by a comparator are delivered to other pins of the driver so as to drive the detected motor. However, instead of back EMF constants respectively corresponding to the three phase windings, the obtained back EMF constant of this conventional measuring method corresponds to the whole three-phase winding system, and may not help the adjustment and analysis in respect phase winding of this three-phase motor. Besides, through this measuring method, circuit connection of the detected motor has to be changed before it is ready for the above measuring steps.

In light of the above conventional measuring methods, it is desired to improve the conventional back EMF measuring methods.

### SUMMARY OF THE INVENTION

It is therefore the primary objective of this invention to provide a back EMF measuring method for multi-phase BLDC motor, which can avoid additional mechanical arrangement for driving a detected motor.

Another objective of this invention is to provide a back EMF measuring method for multi-phase BLDC motor, which provides a non-limited measuring time period.

Still another object of this invention is to provide a back EMF measuring method for multi-phase BLDC motor, which can prevent a detected motor from any change in circuit connection.

Still another object of this invention is to provide a back EMF measuring method for multi-phase BLDC motor, which can obtain back EMF of individual phase winding.

The invention discloses a back EMF measuring method for multi-phase BLDC motor, which includes a driving process and a measuring process. The driving process energizes a plurality of phase windings of a detected motor by driving signals generated by a computing unit to rotate a rotor of the detected motor to a predetermined speed. The measuring process selects one of the phase windings as a target phase winding, continuously sends the driving signals to the phase windings other than the target phase winding but stops the driving signal sent to the target phase winding by the computing unit, and measures the back EMF of the target phase winding by a signal sensing unit.

Furthermore, a re-measure-determining process is proceeded by the computing unit after the measuring process, the re-measure-determining process determines whether a re-measuring command is raised, and the computing unit proceeds the measuring process for the same or another one of the phase windings if the re-measuring command is raised or the computing unit outputs an end report if no re-measuring command is raised.

Furthermore, a re-measure-determining process is proceeded by the computing unit after the measuring process, the re-measure-determining process determines whether a re-measuring command is raised, and the computing unit proceeds a re-drive-determining process if the re-measuring command is raised or the computing unit outputs an end report if no re-measuring command is raised.

Furthermore, the re-drive-determining process determines whether a re-driving command is raised, and the computing unit proceeds the driving process if the re-driving command is raised or the measuring process for the same or another one of the phase windings if no re-driving command is raised.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a flowchart of a back EMF measuring method for multi-phase BLDC motor in accordance with a first embodiment of the invention.

FIG. 2 shows a sketch view of the back EMF measuring method for multi-phase BLDC motor in accordance with the first embodiment of the invention.

FIG. 3 shows a flowchart of a back EMF measuring method for multi-phase BLDC motor in accordance with a second embodiment of the invention.

FIG. 4 shows a circuit diagram of a two-phase motor as a detected motor of a back EMF measuring method for multi-phase BLDC motor of the invention.

FIG. 5 shows a circuit diagram of a three-phase motor as a detected motor of a back EMF measuring method for multi-phase BLDC motor of the invention.

FIG. 6 shows a sketch view of currents in the three-phase motor as the detected motor of a back EMF measuring method for multi-phase BLDC motor of the invention.

In the various figures of the drawings, the same numerals designate the same or similar parts. Furthermore, when the term “first”, “second”, and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

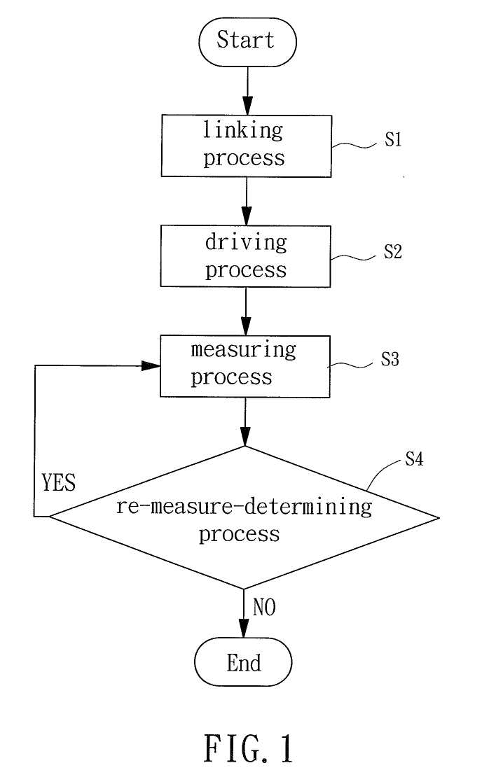

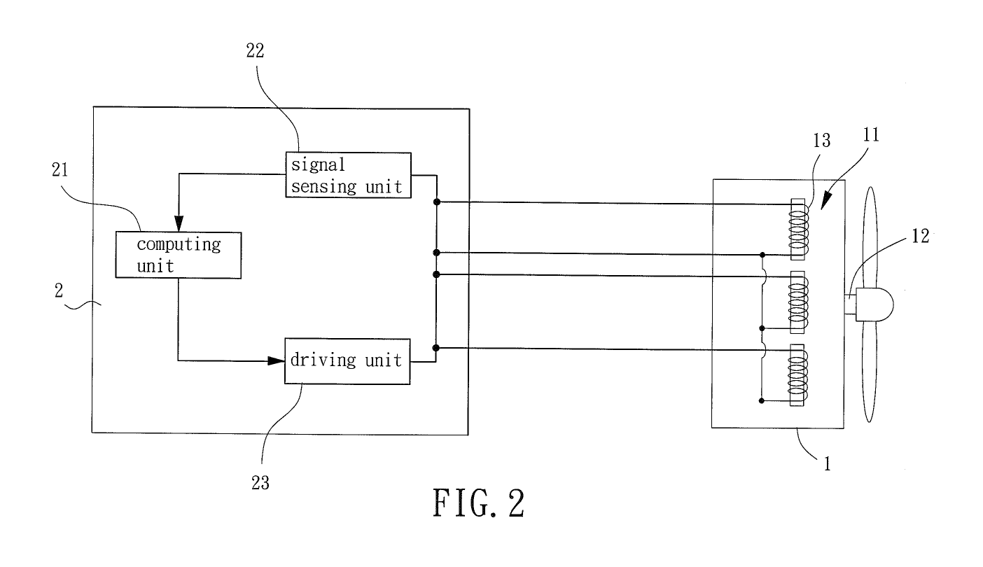

Referring to FIGS. 1 and 2, a flowchart and a sketch view of a first embodiment in accordance with a back EMF measuring method for multi-phase BLDC motor are shown. In this embodiment, a three-phase motor is taken as an example and designated as detected motor 1 for illustration; however, in addition to the shown three-phase motor, the proposed back EMF measuring method can be applied to any kind of BLDC motor with plural phase windings. The detected motor 1 includes a plurality of phase windings 11 and a rotor 12, wherein one of the phase windings 11 is selected as a target phase winding 13, and the phase windings 11 are adapted to rotate the rotor 12. Referring to FIG. 2 again, a measuring device 2 including a computing unit 21, a signal sensing unit 22, and a driving unit 23 to complete the proposed back EMF measuring method is also shown, with the computing unit 21 electrically connecting with the signal sensing unit 22 and driving unit 23. The signal sensing unit 22 can sense signals of the detected motor 1 and send the signals to the computing unit 21 for signal process, and the driving unit 23 is controlled by the computing unit 21 and sends driving signals to the detected motor 1 so as to control the detected motor 1. Accordingly, a preparing process can be executed to provide the measuring device 2 before any other process of this back EMF measuring method is proceeded. Referring to FIG. 1, the first embodiment of the proposed back EMF measuring method includes a linking process S1, a driving process S2, a measuring process S3, and a re-measure-determining process S4. In the linking process S1, the plurality of phase windings 11 is electrically connected with the signal sensing unit 22 and driving unit 23. In the driving process S2, the driving unit 23 energizes the phase windings 11 of the detected motor 1 by driving signals to rotate the rotor 12 to a predetermined speed according to a driving mode of the detected motor 1. In the measuring process S3, by the computing unit 21, one of the phase windings 11 is selected as the target phase winding 13, the driving signals are continuously sent to the phase windings 11 other than the target phase winding 13, and the signal sensing unit 22 of the measuring device 2 measures the back EMF of the target phase winding 13 for the computing unit 21 to calculate the back EMF constant of the target phase winding 13. In the re-measure-determining process S4, the computing unit 21 determines whether a re-measuring command is raised. If the re-measuring command is raised, the computing unit 21 proceeds the measuring process S3 for the same or another one of the phase windings 11; otherwise, the computing unit 21 outputs an end report if no re-measuring command is raised.

Specifically, in accordance with the detected motor 1, which can be a sensing motor or a senseless motor, the linking process S1 may be executed in two ways. One of these two ways, which is executed when the detected motor 1 is a sensing motor, is electrically connecting signal pins of the measuring device 2 with the phase windings 11 and Hall sensor; and the other way executed when the detected motor 1 is a senseless motor is electrically connecting the signal pins of the measuring device 2 with the phase windings 11 only.

The driving process S2 may also be executed in two ways according to the type of the detected motor 1, that is, a sensing motor or a senseless motor. If the detected motor 1 is a sensing motor, according to signals generated by the Hall sensor of the detected motor 1, driving signals such as a set of square wave signals with a time shift between any two square wave signals are generated by the computing unit 21 and respectively sent to the phase windings 11 of the detected motor 1, so as to drive the rotor 12 of the detected motor 1 to the predetermined speed. On the other hand, if the detected motor 1 is a senseless motor, any kind of senseless driving algorithm can be used. For example, a position of the rotor 12 is detected by a position detecting step firstly, and then an open loop driving algorithm may produce driving signals to control the phase windings 11 of the detected motor 1, so as to drive the rotor 12 of the detected motor 1 to the predetermined speed. Besides, with information of zero-crossing points of EMF, the computing unit 21 can calculate an estimated position of the rotor 12 and proceed a close loop driving algorithm in accordance with the estimated position to maintain the predetermined speed of the rotor 12.

The measuring process S3 adjusts the driving signals generated by the computing unit 21 in the driving process S2 after the predetermined speed is achieved and measures the back EMF of the target phase winding 13 by the signal sensing unit 22. Specifically, the computing unit 21 firstly designated one of the phase windings 11 of the detected motor 1 as the target phase winding 13 when the phase windings 11 is ready for back EMF measurement, and the driving signal for the target phase winding 13 is forbidden to energize the target phase winding 13 while other driving signals continue to be sent to the phase windings 11 except for the target phase winding 13. Therefore, the rotor 12 can be continuously rotated by the energized phase windings 11 without the target phase winding 13, and the signal sensing unit 22 can measure the back EMF of the target phase winding 13 for the computing unit 21 to calculate the back EMF constant thereof.

The re-measure-determining process S4 determines whether the re-measuring command is raised so as to proceed the measuring process S3 for any one of the phase windings 11 or output the end report. In detail, according to functions previously set in the computing unit 21, the source of the re-measuring command may be the computing unit 21 or an order given by a user toward the computing unit 21. Moreover, the selected phase winding 11 as the target phase winding 13 of the following measuring process S3 can be the same or another one of the phase windings 11.

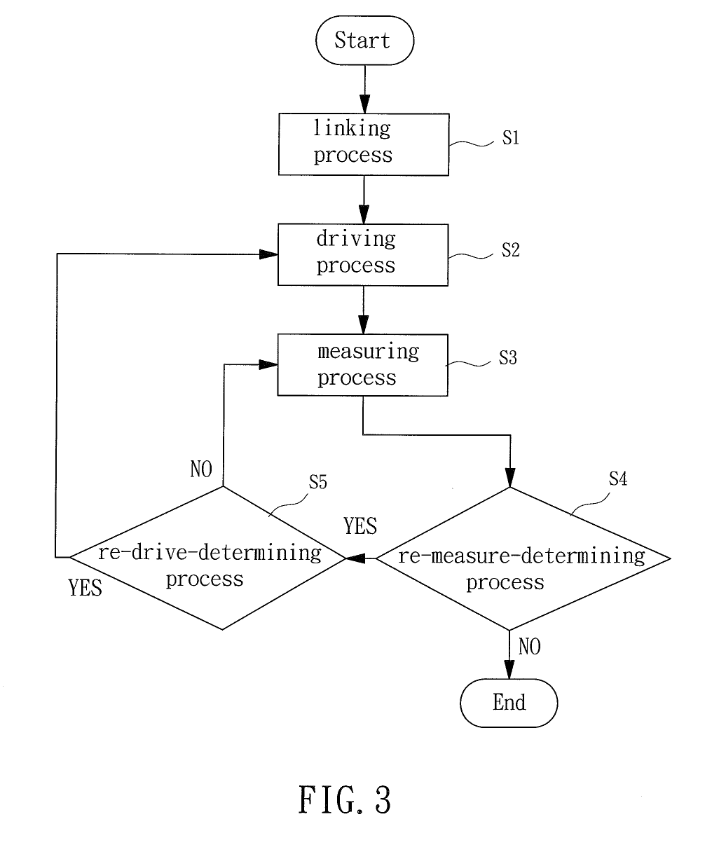

Referring to FIG. 3, a flowchart of a second embodiment in accordance with the back EMF measuring method for multi-phase BLDC motor is shown. In comparison with the first embodiment, instead of the measuring process S3, a re-drive-determining process S5 is executed when the re-measuring command is raised in the re-measure-determining process S4. In detail, the re-drive-determining process S5 determines whether a re-driving command is raised, and the computing unit 21 proceeds the driving process S2 if the re-driving command is raised or the measuring process S3 for the same or another one of the phase windings 11 if no re-driving command is raised. Specifically, the computing unit 21 may not raise the re-driving command until a comparison, which is between the present speed of the rotor 12 and the predetermined speed or between the present speed of the rotor 12 and a re-driving speed lower than the predetermined speed, is done and the present speed of the rotor 12 is lower than the predetermined speed or re-driving speed. Similarly, the source of the re-driving command may be the computing unit 21 or an order given by a user toward the computing unit 21.

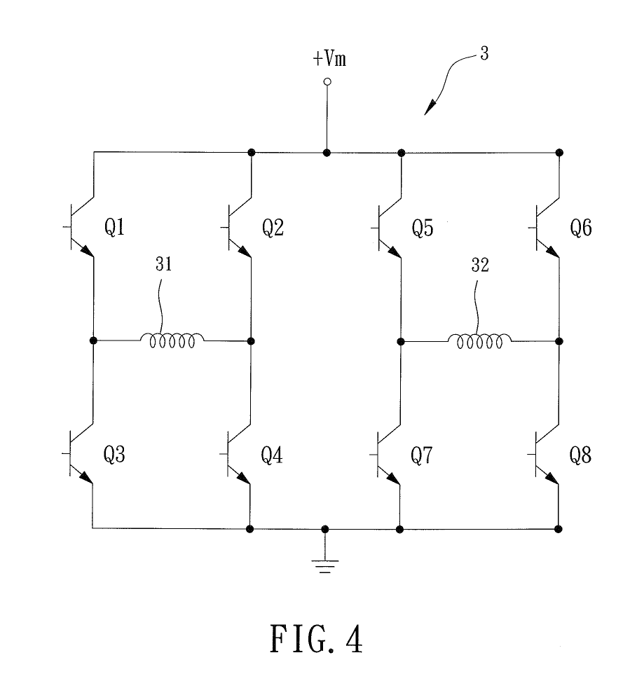

In the following, a two-phase motor and a three-phase motor are taken as examples of the detected motor 1 for a further illustration of the present back EMF measuring method. Please refer to FIG. 4, which illustrates the circuit of the two-phase motor 3 including an A-phase winding 31, a B-phase winding 32, and a plurality of transistor switches Q1, Q2, Q3, Q4, Q5, Q6, Q7, Q8. In the driving process S2, the A-phase winding 31 and B-phase winding 32 can be separately operated and energized according to the following Table 1 to rotate the rotor of this two-phase motor 3 to the determined speed. Particularly, there is an electrical angle shift of 90 degrees between the A-phase winding 31 and B-phase winding 32, with the “+” and “−” representing different current directions of the windings 31, 32.

TABLE 1

state

| | 1 | 2 | 3 | 4 |
|---|---|---|---|---|
| Electrical angle | 0-90 | 90-180 | 180-270 | 270-360 |
| A-phase winding | + | + | − | − |
| B-phase winding | − | + | + | − |

In the measuring process S3, when the A-phase winding 31 is selected as the target phase winding, the A-phase winding 31 and B-phase winding 32 can be controlled according to the following Table 2, with all the transistor switches Q1, Q2, Q3, Q4 connecting with the A-phase winding 31 turned off, so that the A-phase winding 31 may not be energized in every position of all electrical angles, which is denoted by “N” in the Table 2. Accordingly, the energized B-phase winding 32 can continuously rotate the rotor of the two-phase motor 3 while the back EMF of the A-phase winding 31 is measured to obtain the back EMF constant thereof.

TABLE 2

state

| | 1 | 2 | 3 | 4 |
|---|---|---|---|---|
| Electrical angle | 0-90 | 90-180 | 180-270 | 270-360 |
| A-phase winding | N | N | N | N |
| B-phase winding | − | + | + | − |

In the above example, the speed of the rotor can still be larger than the predetermined speed in the measuring process S3 since the rotor has been speeded up to the predetermined speed by both phase windings 31, 32 in the driving process S2 and is continuously rotated by the B-phase winding 32 in the measuring process S3 to maintain its speed. On the contrary, when the B-phase winding 32 is selected as the target phase winding, all the transistor switches Q5, Q6, Q7, Q8 connecting with the B-phase winding 32 is turned off, and the energized A-phase winding 31 can continuously rotate the rotor of the two-phase motor 3 while the back EMF of the B-phase winding 32 is measured to obtain the back EMF constant thereof.

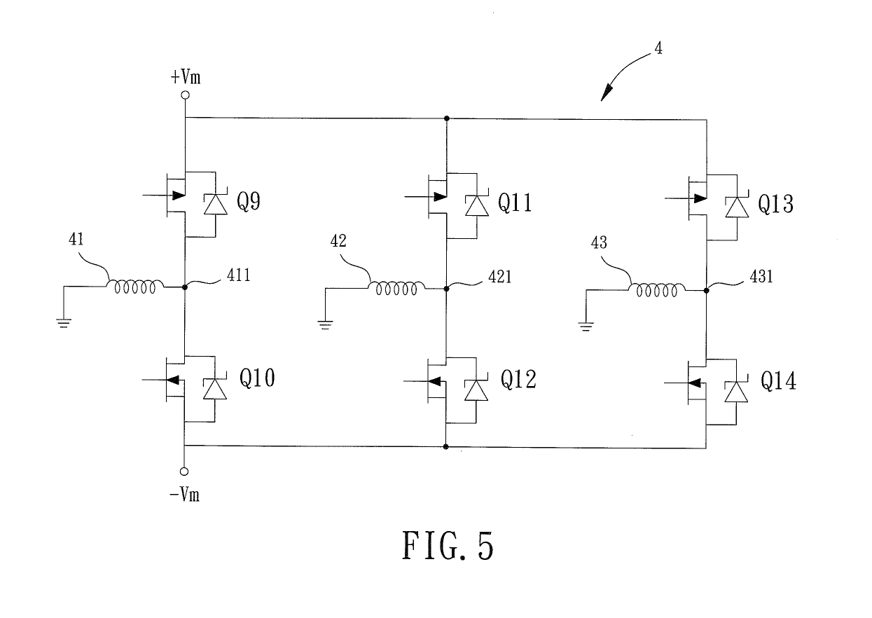

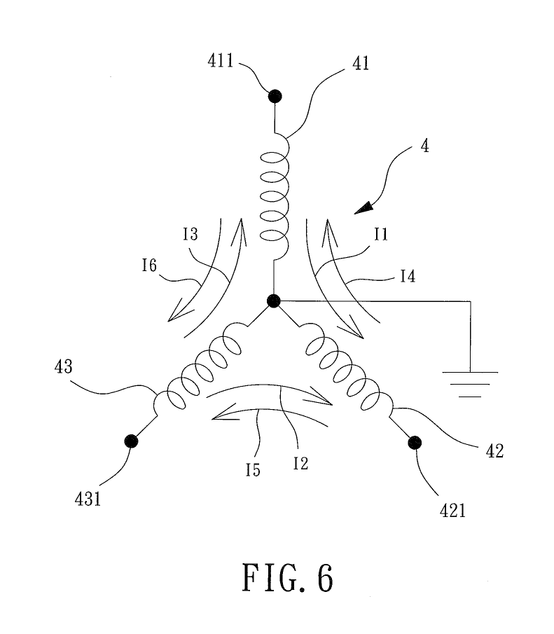

Please refer to FIG. 5, which illustrates the circuit of the three-phase motor 4 including an A-phase winding 41, a B-phase winding 42, a C-phase winding 43, and a plurality of transistor switches Q9, Q10, Q11, Q12, Q13, Q14, wherein the A-phase winding 41 has an end 411 connecting with the transistor switches Q9, Q10, the B-phase winding 42 has an end 421 connecting with the transistor switches Q11, Q12, and the C-phase winding 43 has an end 431 connecting with the transistor switches Q13, Q14. In the driving process S2, the A-phase winding 41, B-phase winding 42, and C-phase winding 43 can be separately operated and energized according to the following Table 3 to rotate the rotor of this three-phase motor 4 to the determined speed, wherein the “+” and “−” represent different current directions of the windings 41, 42, 43. Furthermore, corresponding to the states 1-6 in Table 3, currents I1, I2, I3, I4, I5, I6 passing through the windings 41, 42, 43 are shown in FIG. 6.

TABLE 3

| state | 1 | 2 | 3 | 4 | 5 | 6 |
|---|---|---|---|---|---|---|
| Electrical angle | 0-60 | 60-120 | 120-180 | 180-240 | 240-300 | 300-360 |
| A-phase winding | + | N | − | − | N | + |
| B-phase winding | − | − | N | + | + | N |
| C-phase winding | N | + | + | N | − | − |

In the measuring process S3, when the A-phase winding 41 is selected as the target phase winding, the A-phase winding 41, B-phase winding 42, and C-phase winding 43 can be controlled according to the following Table 4, with both transistor switches Q9, Q10 connecting with the A-phase winding 31 turned off, so that the A-phase winding 41 may not be energized in every position of all electrical angles, which is denoted by “N” in the Table 4. In this situation, only the currents I2, I5 in state 2 and state 5 are normally supplied to the B-phase winding 42 and C-phase winding 43, and the other currents I1, I3, I4, I6 in state 1, state 3, state 4, and state 6 are changed wherein only parts of the currents I1, I3, I4, I6 passing though the B-phase winding 42 or C-phase winding 43 exist. Accordingly, the energized B-phase winding 42 and energized C-phase winding 43 can continuously rotate the rotor of the three-phase motor 4 while the back EMF of the A-phase winding 41 is measured to obtain the back EMF constant thereof.

TABLE 4

| state | 1 | 2 | 3 | 4 | 5 | 6 |
|---|---|---|---|---|---|---|
| Electrical angle | 0-60 | 60-120 | 120-180 | 180-240 | 240-300 | 300-360 |
| A-phase winding | N | N | N | N | N | N |
| B-phase winding | − | − | N | + | + | N |
| C-phase winding | N | + | + | N | − | − |

The speed of the rotor of the three-phase motor 4 can still be larger than the predetermined speed in the measuring process S3 since the rotor has been speeded up to the predetermined speed by all the phase windings 41, 42, 43 in the driving process S2 and is continuously rotated by the B-phase winding 42 and C-phase winding 43 in the measuring process S3 to maintain its speed. In the same way, the back EMF constants of the B-phase winding 42 and C-phase winding 43 are obtainable.

In sum, in accordance with the back EMF measuring method of this invention, no matter a multi-phase BLDC motor is a sensing motor or a senseless motor, only the driving signals for the phase windings are adjusted to sequentially obtain the back EMF of the phase windings and acquire the back EMF constants thereof. Therefore, the present back EMF measuring method not only avoids measuring errors caused by additional mechanical arrangement but also provides a non-limited measuring time period, and can prevent the detected multi-phase BLDC motor from any change in circuit connection.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A back EMF measuring method for multi-phase BLDC motor, comprising:
a driving process energizing a plurality of phase windings of a detected motor by driving signals generated by a computing unit to rotate a rotor of the detected motor to a predetermined speed; and
a measuring process selecting one of the phase windings as a target phase winding and continuously sending the driving signals to the phase windings other than the target phase winding but stopping the driving signal sent to the target phase winding by the computing unit, and measuring the back EMF of the target phase winding by a signal sensing unit.

2. The back EMF measuring method for multi-phase BLDC motor as claimed in claim 1, wherein a re-measure-determining process is proceeded by the computing unit after the measuring process, the re-measure-determining process determines whether a re-measuring command is raised, and the computing unit proceeds the measuring process for the same or another one of the phase windings if the re-measuring command is raised or the computing unit outputs an end report if no re-measuring command is raised.

3. The back EMF measuring method for multi-phase BLDC motor as claimed in claim 1, wherein a re-measure-determining process is proceeded by the computing unit after the measuring process, the re-measure-determining process determines whether a re-measuring command is raised, and the computing unit proceeds a re-drive-determining process if the re-measuring command is raised or the computing unit outputs an end report if no re-measuring command is raised.

4. The back EMF measuring method for multi-phase BLDC motor as claimed in claim 3, wherein the re-drive-determining process determines whether a re-driving command is raised, and the computing unit proceeds the driving process if the re-driving command is raised or the measuring process for the same or another one of the phase windings if no re-driving command is raised.

5. The back EMF measuring method for multi-phase BLDC motor as claimed in claim 1, wherein a preparing process is executed before the driving process to provide the computing unit, the signal sensing unit and a driving unit of a measuring device, with the driving unit being adapted to transmit the driving signals to the phase windings of the detected motor.

6. The back EMF measuring method for multi-phase BLDC motor as claimed in claim 5, wherein the signal sensing unit senses signals of the detected motor and sends the signals to the computing unit for signal process, and the driving unit is controlled by the computing unit to send the driving signals to the detected motor.

7. The back EMF measuring method for multi-phase BLDC motor as claimed in claim 6, wherein a linking process is executed before the driving process to electrically connect the plurality of phase windings to the signal sensing unit and driving unit.
